(19) United States
(12) Patent Application Publication
(10) Pub. No.: US 2010/0276453 A1
(43) Pub. Date: Nov. 4, 2010

(54) APPARATUS FOR SERVING WINE OR OTHER OXYGEN-AFFECTED LIQUID FROM A BOTTLE

(75) Inventor: Jacques Valere Vandaele, Wielsbeke (BE)

Correspondence Address: DENNISON, SCHULTZ & MACDONALD, 1727 KING STREET, SUITE 105, ALEXANDRIA, VA, 22314, US

(73) Assignee: WINEFIT S.R.L., Calenzano (IT)

(21) Appl. No.: 12/742,838

(22) PCT Filed: Nov. 28, 2007
(86) PCT No.: PCT/EP2007/010328

§ 371 Date: Jun. 29, 2010

(51) Int. Cl. B67D 1/08; B65D 83/00

(52) U.S. Cl. 222/152; 222/399

(57) ABSTRACT

A serving apparatus without oxygen, from an open bottle, of a liquid that can be affected by oxygen, in particular wine, by insufflating inert pressurized gas in said bottle, comprising a fixed engagement member (1) and a releasable fastening member (2) fixed to a bottle (30). A pressurized gas supply without oxygen is provided, for example nitrogen or argon, having for example a cylinder (41) connected to a gas supply machine (40). By the gas supply machine (40) the pressurized gas can be distributed and supplied in the bottles (30), flowing through a pressure reducing valve (42), a pressure switch (43) for indication of the lack of gas in the cylinder (41), a solenoid valve (44) adapted to delivery gas on driving the pressure switch (47), a safety valve (45) adapted to avoid that a maximum threshold value is exceeded, a gas tank (46) that prevents a solenoid valve (44) from opening continuously, a pressure switch (47) adapted to keep the pressure in the bottle (30) fixed.

### FIELD OF THE INVENTION

The present invention relates to an apparatus capable of serving from a bottle a liquid that can be affected by oxygen, and of stopping automatically the bottle after serving.

The invention is, in particular, adapted to the field of enology, for serving by-the-glass valuable wine from a bottle, in particular, for use in wine cellars, wine shops, bars, restaurants.

### DESCRIPTION OF THE TECHNICAL PROBLEM

Apparatus exist capable of serving by-the-glass wine from a bottle and of stopping automatically the bottle after serving. However, like other liquids, wine tends to be affected by the oxygen present in the air. So, both when serving and when closing the bottle after serving, the air entered in the bottle unavoidably affects the wine.

The problem has been overcome by an automatic device capable of pouring wine out from a bottle, through a thin delivery tube, by insufflating in the bottle a pressurized gas that do not contain oxygen, for example inert gas such as nitrogen or a noble gas such as argon. By progressively insufflating gas in the bottle, the increasing pressure in the bottle forces the wine to exit from the thin delivery tube.

This device comprises a cylinder containing a pressurized gas, a supply connection engageable with the bottleneck, having a thin inlet tube for conveying the pressurized gas in the bottle, a thin delivery tube, an gas inlet duct from the cylinder to the supply connection. The thin delivery tube can comprise a tap for pouring out the wine when open. Such a system prevents air from entering the bottle both when pouring the wine out and when the wine is stored in the already opened bottle.

A drawback of such a device is that it is not possible to change a first bottle with a second bottle before that the first bottle of wine is empty, because the change would cause air to enter in the first bottle, affecting the wine, so that the wine in that bottle can be preserved only for a short time.

Therefore, it is not possible to use one device of the known type for serving two different types of wine in turn. In particular, according to such prior art, for serving two different types of wine by the glass it is necessary to provide one device for each bottle of wine, because each bottle has to be mounted on a respective device for all the time up to emptying it.

For this reason, a main drawback of the known art is that many devices for different wines have to be provided in parallel, and large spaces are required in restaurants and wine shops. Since one device has a size about of 200×300×500 mm, the overall encumbrance, which would be proportional to the number of wine bottles, would be high. Not only the spaces but also the costs would be relevant, and the overall cost of the plant would increase proportionally with the number of different bottles of wine. This would limit the number of types of wines to be offered to-the-glass to the public.

### SUMMARY OF THE INVENTION

It is then a feature of the present invention to provide an apparatus for serving by-the-glass wine from a bottle, or other liquid that can be affected by oxygen, that allows to switch from a first bottle partially used with another bottle, ensuring an optimal preservation of the wine also in the first bottle.

Another feature of the present invention is to provide an apparatus for serving by-the-glass wine from a bottle, or other liquid that can be affected by oxygen, that allows the use of a single apparatus for serving different wines.

It is still a feature of the invention to provide an apparatus for serving more than one type of wine from bottles without oxygen, which is not cumbersome and not much expensive.

These and other objects are achieved by an apparatus for serving, without oxygen, from an already open bottle, a liquid that can be affected by oxygen, in particular wine, by insufflating inert pressurized gas in said bottle, said bottle having a bottleneck with a mouth, said apparatus comprising a normally closed releasable fastening member, which can be fixed at the mouth of said bottleneck, said releasable fastening member being equipped with:
means for a tight connection with a pressurized gas supply, adapted to receive said pressurized gas and to convey it in the bottle;
means for serving the liquid in occasion of the delivery of the gas, said means for serving being in hydraulic connection with an inner bottom region of the bottle;
means for keeping said bottle closed when it is withdrawn from said pressurized gas supply keeping the pressurized gas in the bottle.

In particular, said means for keeping said bottle closed comprises:
a closure member that can be fixed at the mouth of said bottle by releasable fastening means, said closure member having a pressurized gas inlet duct, passing through said closure member and leading into said bottle, and a liquid delivery duct, for leading out the liquid from an inner bottom region of the bottle and serving it outside;
a check valve on said inlet duct, adapted to be open when supplying the pressurized gas and to be closed in all the other situations;
a check valve on said liquid delivery duct.

Advantageously, said closure member comprises a cylindrical portion capable of tightly engaging in the bottleneck.

Preferably, said means for a tight connection with a pressurized gas supply comprises a coupling surface engageable with a fixed member belonging to said pressurized gas supply, wherein when said coupling surface engages with said fixed engagement member, said pressurized gas supply is in pneumatic tight connection with said inlet duct.

In particular, said coupling surface is engageable with said fixed engagement member, by a coupling selected from the group comprised of:
bayonet coupling;
screw coupling;
snap coupling;
sliding coupling;
magnetic coupling.

In particular, said means for fixing said closure member at the mouth of said bottle comprises a bush in which said closure member is engageable, said bush having a hook portion that can be fixed to an edge protruding from said bottleneck.

Advantageously, said means for serving the liquid are in hydraulic connection with said liquid delivery duct and are selected from the group comprised of:
a thin liquid free outlet tube
a thin liquid outlet tube with a
opening/closing valve;
an air/liquid mixer.

In particular, said opening/closing valve on said thin tube is selected from the group comprised of:
a push button tap;
a handle tap;
a check valve that opens for serving the wine and that prevents air back flow into the bottle;
a solenoid valve.

Advantageously, said serving apparatus comprises a safety valve adapted to avoid the pressure of the gas in the bottle exceeds a threshold value.

According to another aspect of the invention, a machine for distribution, without oxygen, from an already open bottle, a liquid that can be affected by oxygen, in particular wine, by insufflating inert pressurized gas in said bottle, comprises:
a normally closed releasable fastening member, which can be fixed at the mouth of said bottleneck, said releasable fastening member being adapted to receive said pressurized gas leading it into the bottle and comprising means for serving the liquid in occasion of the delivery of the gas;
a fixed engagement member adapted to receive said releasable fastening member;
a gas delivery valve associated with said fixed engagement member;
a pressurized gas supplier in pneumatic connection with said gas delivery valve;
tight engagement means between said gas delivery valve and said releasable fastening member;
means for testing the presence of said releasable fastening member on said fixed engagement member.

Advantageously, said gas delivery valve is operated by a push button or equivalent operating device. This way, the user brings the bottle with the releasable fastening member to engage with the fixed engagement member, then brings a glass at the means for serving the liquid, presses the push button up to filling the glass with a desired amount of liquid.

Advantageously, said gas delivery valve is selected from the group comprised of: a mechanical valve operated by said push button; a solenoid valve operated by said push button.

Preferably, the tight engagement means between said gas delivery valve and said releasable fastening member comprises a membrane adapted to mate tightly the surface of said means for a tight engagement of said releasable fastening member, said membrane changing its shape under the pressure of the delivered gas to ensure said tight connection, a calibrated stopper being provided to allow the deformation of said membrane before allowing the flow of the gas towards said releasable fastening member.

Advantageously, said fixed engagement member comprises a sensor of presence of said releasable fastening member, whereby in presence/absence of said releasable fastening member said sensor respectively allows/ blocks, the operation of said delivery valve.

Preferably, said fixed engagement member is a guide member, and said releasable fastening member has a flange that slidingly engages with said guide, up to substantially aligning said releasable fastening member with said delivery valve.

Advantageously, said pressurized gas supplier comprises a safety pressure switch adapted to limit the pressure of the gas in the bottle below a predetermined pressure value.

Advantageously, said pressurized gas supplier is selected from the group comprised of:
a gas cylinder;
a gas supply network.

Preferably said gas cylinder has volume less than 1.5 litres.

In particular, said gas cylinder comprises a pressure reducing valve.

Advantageously, said pressurized gas is an inert gas and/or a noble gas not containing oxygen, in order not to oxidize the wine, and, in particular, is selected from the group comprised of:
nitrogen;
argon.

In a preferred exemplary embodiment, said machine comprises a plurality of fixed engagement members for respective coupling surfaces and respective bottles of different wines.

### BRIEF DESCRIPTION OF THE DRAWINGS

The invention will be made clearer with the following description of an exemplary embodiment thereof, exemplifying but not limitative, with reference to the attached drawings wherein:

FIG. 1 shows an apparatus according to the invention for delivery, without oxygen, of wine or other liquids that can be affected by oxygen, having three releasable fastening members according to the invention;

FIG. 2 shows a hydraulic diagram of such an apparatus;

FIG. 3 shows a cross sectional view of a fixed engagement member of a gas supply adapted to engage with a releasable fastening member according to the invention;

FIG. 4 shows a fastening element for fixing a releasable fastening member according to the invention at the mouth of a bottle;

FIG. 5 shows a cross sectional view of a releasable fastening member applied to a bottle by a fastening element and applied to a fixed engagement member of a gas supply in a first embodiment of the invention;

FIG. 6 shows a cross sectional view of a releasable fastening member applied to a bottle by a fastening element and applied to a fixed engagement member of a gas supply in a second embodiment of the invention;

FIG. 7 shows an exploded sectional view of FIG. 6 showing the releasable fastening member and the fixed engagement member with relative inner parts;

FIG. 8 shows an engagement step of a bottle, having a releasable fastening member, with the fixed engagement member, of a machine for serving a liquid from a bottle in a second embodiment of the invention;

FIG. 9 shows the operation of the machine of FIG. 8 when serving a liquid in a glass;

FIG. 10 shows a cross sectional view of an air/liquid mixer that exploits, in particular, the Venturi effect;

FIG. 11 shows the machine of FIG. 9 having the air/liquid mixer of FIG. 10.

### DESCRIPTION OF THE PREFERRED EXEMPLARY EMBODIMENT

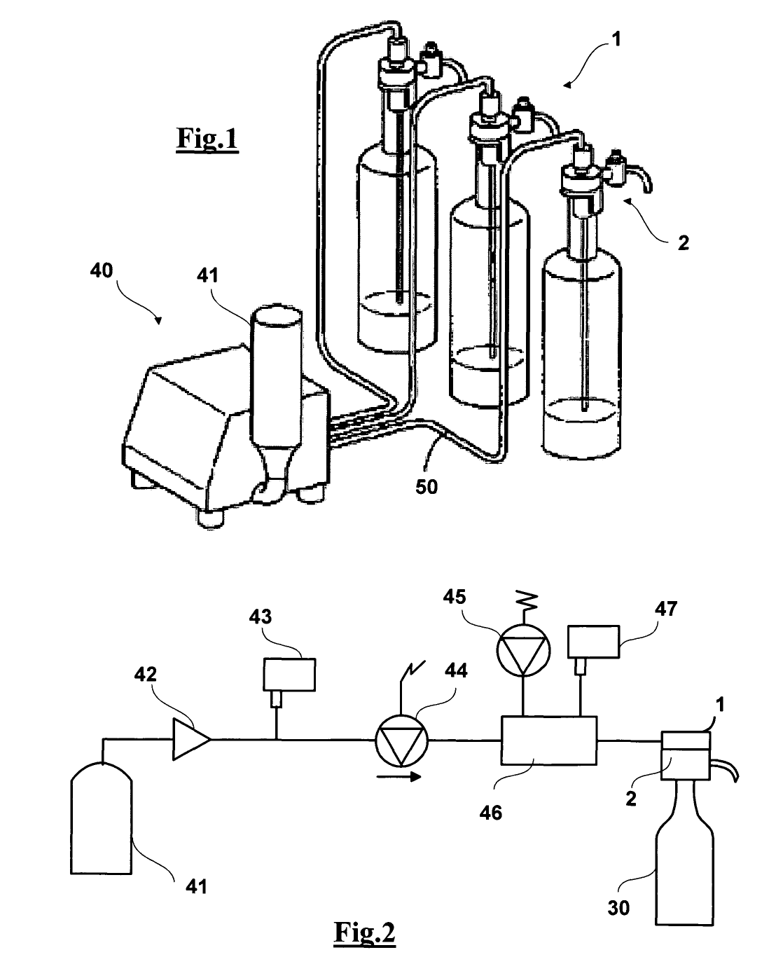

With reference to FIG. 1, an example is depicted in a perspective view of an apparatus for serving a liquid without oxygen according to the invention. In particular, as shown, three delivery outlets are provided, each formed respectively by a fixed engagement member 1 and a releasable fastening member 2 that can be fixed to a bottle 30.

Obviously, even if an example of a serving apparatus is described having three connections for three respective bottles, exemplary embodiments are not excluded with a single releasable fastening member or with another number thereof.

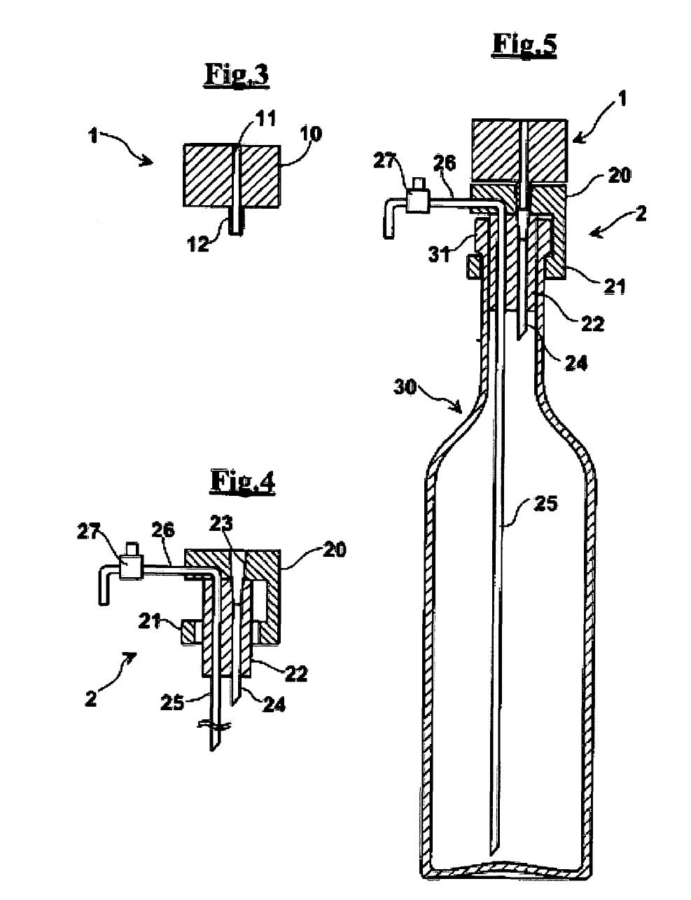

The serving apparatus comprises a pressurized gas supply without oxygen, such as an inert gas, for example nitrogen or argon, having for example a cylinder 41 connected to a gas supply machine 40, whose operation is described in the diagram of FIG. 2. By means of gas supply machine 40 the pressurized gas is distributed and supplied into bottles 30, flowing through ducts 50.

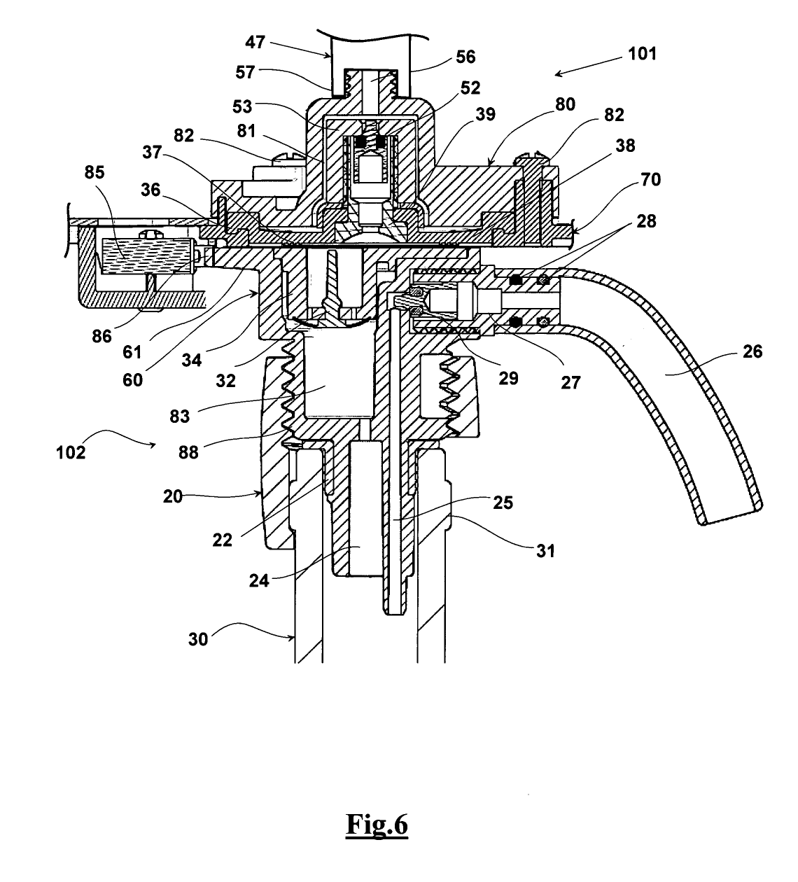

FIGS. 3, 4 and 5 show in more detail, according to the invention, a fixed engagement member 1, connected in a way not shown to a duct 50, and a releasable fastening member 2.

FIG. 2 shows a hydraulic diagram of the serving apparatus comprising in succession: a cylinder 41 containing an inert gas, a pressure reducing valve 42, a pressure switch 43 for indication of a lack of gas in the cylinder 41, a solenoid valve 44 adapted to delivery gas, a safety valve 45 adapted to limit the pressure below a maximum threshold value, an gas tank 46 that prevents a solenoid valve 44 to open continuously, a pressure switch 47 adapted to keep the pressure in a bottle 30 steady by influencing solenoid valve 44, and finally, a serving device formed respectively by a fixed engagement member 1 and a releasable fastening member 2 that is fixed to bottle 30, in particular a wine bottle.

FIG. 3 shows a cross section of fixed engagement member 1 comprising a block 10 crossed by a channel 11, fitted in a way not shown to tube 50. For example, channel 11 ends with a collector 12 capable of tightly engaging with a corresponding hole 23 (FIG. 4) obtained on releasable fastening member 2. Obviously, various exemplary embodiment are possible of the couplings between fixed engagement member 1 and releasable fastening member 2.

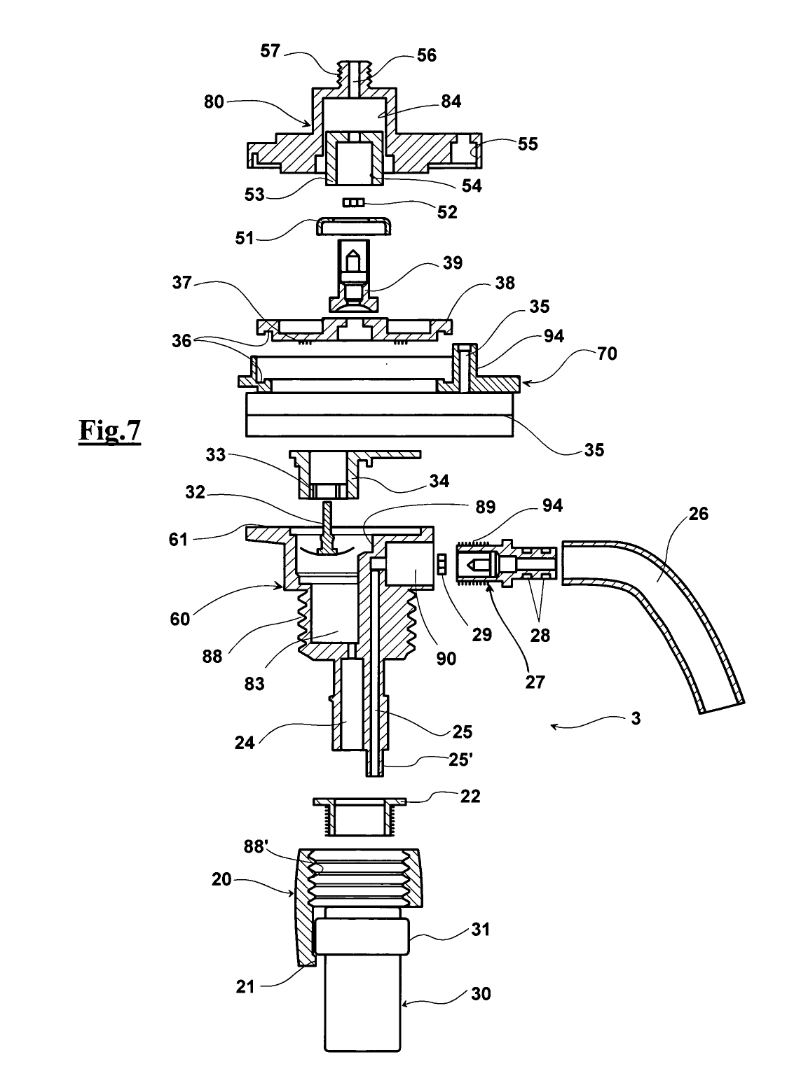

FIG. 4 shows a cross section of releasable fastening member 2, which can be operatively fixed to the mouth of a bottle 30 (FIG. 5). Releasable fastening member 2 comprises a fastening element 20 having means for coupling 21 to a ring protruding from the bottleneck. Furthermore, releasable fastening member 2 comprises a cylindrical portion 22 adapted to be put in the mouth of the bottleneck to ensure a tight connection. Releasable fastening member 2 is crossed by a pressurized gas inlet duct 24 leading into the bottle, of reduced length in order not to bubble gas in the wine contained in the bottle. Releasable fastening member 2 is crossed also by a delivery duct 25 longer than duct 24 and reaching the inner bottom region of the bottle. A serving valve 27, normally closed, for example a push button, is mounted on serving duct 26, that continues from duct 25.

FIG. 5 shows such a releasable fastening member 2 and fixed engagement member 1 operatively coupled to allow the distribution of wine without oxygen. As shown, after having been opened a first time, bottle 30 is closed by releasable fastening member 2 and put away like a closed bottle of wine, for example laid down, upright, in a refrigerator, etc., ready for use. The presence of the inert gas inside allows to preserve the wine for a long time, even 10-15 days after opening the bottle, without loosing its organoleptic qualities.

When serving again wine, the operation of such a serving device provides the step of insufflating the inert pressurized gas into bottle 30. The pressurized gas pushes the wine contained in the bottle that goes up duct 25 exits from the bottle through serving duct 26 (FIG. 5) equipped with a normally closed serving valve 27. In fact, when bottle 30, to which releasable fastening member 2 is connected, has releasable fastening member 2 coupled to engagement member 1, when opening valve 27 an amount of wine is supplied without that air enters the bottle. When, a first bottle of a wine has to be replaced with a second bottle containing another wine to be served by the glass, the first bottle is simply disengaged, with releasable fastening member 2 that is separated from fixed engagement member 1, which is coupled to the second bottle. When releasable fastening member 2 is separated from fixed engagement member 1, suitable check valves mounted on duct 24 and not shown in FIG. 5, block the outlet of the pressurized gas previously put in the bottle, and at the same time block a back flow of air, in order to preserve most favourably the wine or other liquid contained in the bottle.

A preferred exemplary embodiment of the invention, is depicted in FIG. 6, showing a fixed engagement member 101 and a releasable fastening member 102, coupled operatively to each other. In particular, fixed engagement member 101 comprises a valve unit 80 and a connection member, which preferably is a guide 70, whereas releasable fastening member 102 consists of a joint member 60, for example comprising a flange 61 that engages with guide 70 of fixed engagement member 101 and comprises a fastening element 20 to a bottle 30.

FIG. 6 shows, furthermore, a valve unit 80, fixed to guide 70 by screws 82, and by a joint 57, a solenoid valve 47, partially visible. Valve unit 80 houses a movable element 53 which has a shape and a size such that, when said movable element is a housing 84 (visible in FIG. 7), an annular channel 81 for the gas is formed.

In movable element 53, in a housing 54 thereof (see FIG. 7), a spring loaded stopper 39 is mounted with a respective seal 52.

Furthermore, a membrane 38 is inserted, blocked by gripping members 36, in guide 70. Membrane 38, is capable to be deformed, under the pressure of gas coming from channel 81, so that sealing lips 37 press against joint member 60.

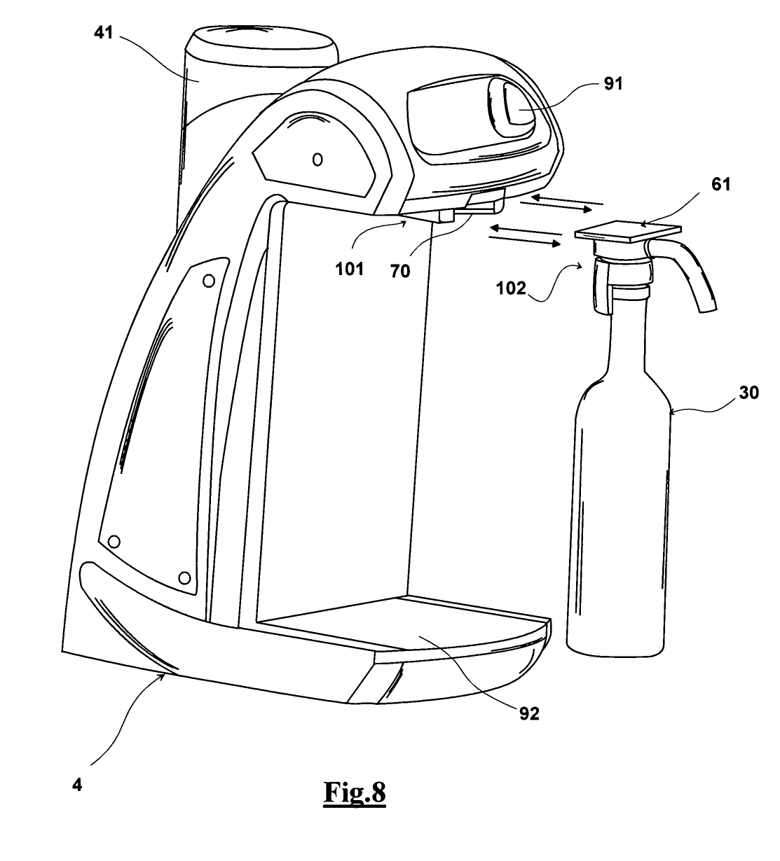

The connection between guide 70 and joint member 60 is obtained bringing flange 61 in the direction of guide 70 (visible in FIG. 8). The connection is signalled by a reed switch 85, integral to the machine, and by a magnetic body 86, integral to joint member 60.

In joint member 60 (see FIG. 6) there are:
a first housing 89 (see FIG. 7);
a valve body 34 arranged in housing 89;
a check valve 32 in said valve body 34 that allows the gas to enter a chamber 83,
a second housing 90 (see FIG. 7);
a serving valve 27, normally closed, inserted in housing 90 with a seal 29, and two o-rings 28 for tight connection with a delivery duct 26,
a inlet duct 24 for the gas, and
a outlet duct 25 for the wine, having a neck end 25′ on which a thin tube not shown is put adapted to extend down to an inner bottom region of the bottle (like FIG. 5).

In the external part of joint member 60 screw threads 88 are made with the function of connecting joint member 60 of the releasable fastening member to fastening element 20, which has respective inner lips 88′, which can be either flexible and circular, for a forced introduction, or helical, for an screw connection.

A sealing bush 22 to be put in the mouth of the bottleneck is provided for sealing the liquid contained in the bottle under the pressure of the gas, as well as a hook 21 is provided on fastening element 20, which engages with a protruding ring edge 31 extending from the neck of bottle 30.

FIG. 7 shows an exploded view of fixed engagement member 1 and of releasable fastening member 2, in a possible exemplary embodiment.

In said figure the following are shown: valve unit 80 with housing 84 for movable unit 53, duct 56 for the gas, joint 57 for connection with solenoid valve 47 (visible partially in FIG. 6) and three housings 55 at 120°. In particular, housings 55 match with protrusions 94 having holes 35, for locking, by screws 82 (shown in FIG. 6), guide 70 with the valve unit 80.

FIG. 7 shows, furthermore, seal 52 mounted between movable element 53 and stopper 39, a protection carter 51 connected to stopper 39, a deformable membrane 38, inserted, by the gripping elements 36 in guide member.

Guide 70, in particular, has a C-shaped profile 35 capable of receiving a complementary flange 61 belonging to joint member 60 (visible in FIG. 8) for connecting the whole apparatus 2 with serving machine 4.

FIG. 7 shows, also, valve body 34, fitted within housing 89, where the holes 33 are made for delivering the gas, controlled by check valve 32, into chamber 83. In joint member 60, furthermore, gas inlet duct 24, delivery duct 25 and second housing 90 for valve 27 are shown. In valve 27, which is forced into second housing 90 by bending rubber ribs 94 and pushing seal 29, are also shown recesses 28 for o-rings which ensure a tight connection with liquid serving duct 26.

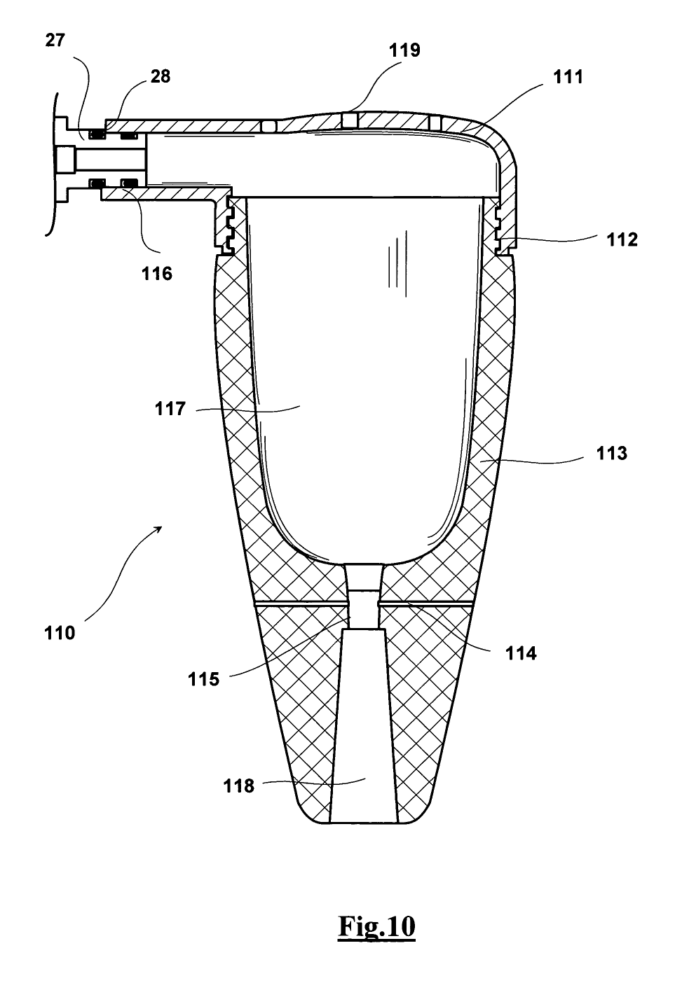

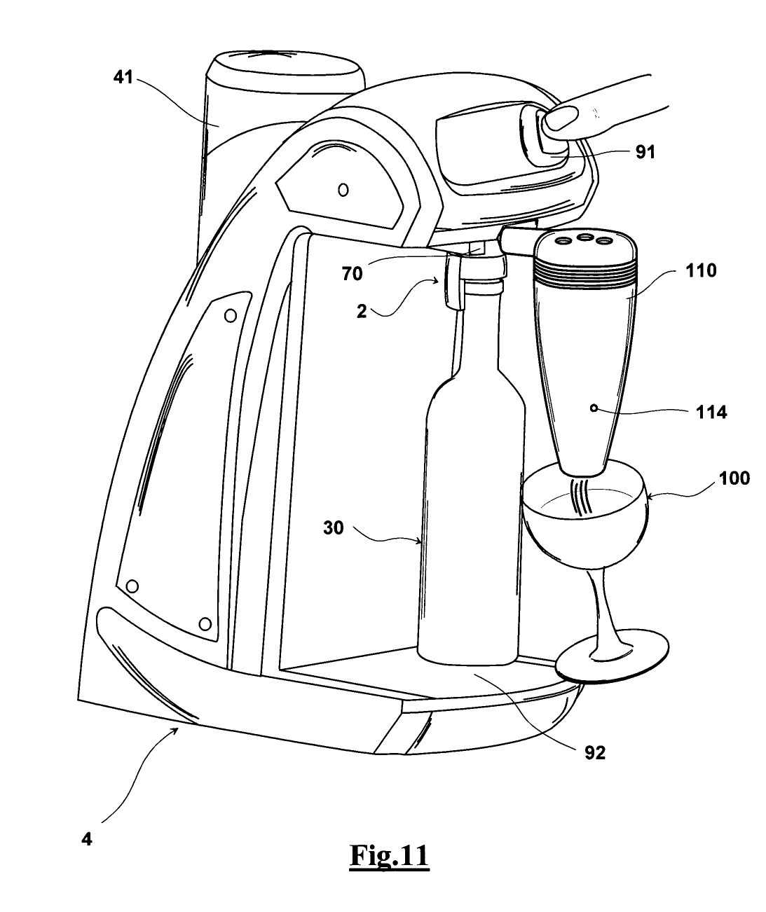

Said serving duct 26 can be replaced, in a possible exemplary embodiment, by a known air-wine mixer 110 that exploits, in particular, the Venturi effect (visible in FIGS. 10 and 11).

FIG. 8 shows a wine serving machine 4 according to the invention in a preferred exemplary embodiment, and integrating fixed engagement member 101 adapted to receive releasable fastening member 102. In particular, as above described, guide 70 is shown, belonging to engagement member 101, where flange 61, which belongs to joint member 60 of releasable fastening member 102, is fitted.

Furthermore, the following are shown: bottle 30, a base grid 92 for collecting under it possible droplets, a gas cylinder 41 (or a relative cylinder holder, where the cylinder is housed) and the serving push button 91 that adjusts valve 47, (partially visible in FIG. 6) serving the wine as hereinafter explained.

As already described with reference to FIG. 5, the gas in bottle 30 allows wine to preserve its quality, and the presence of releasable fastening member 102 allows to serve it when desired.

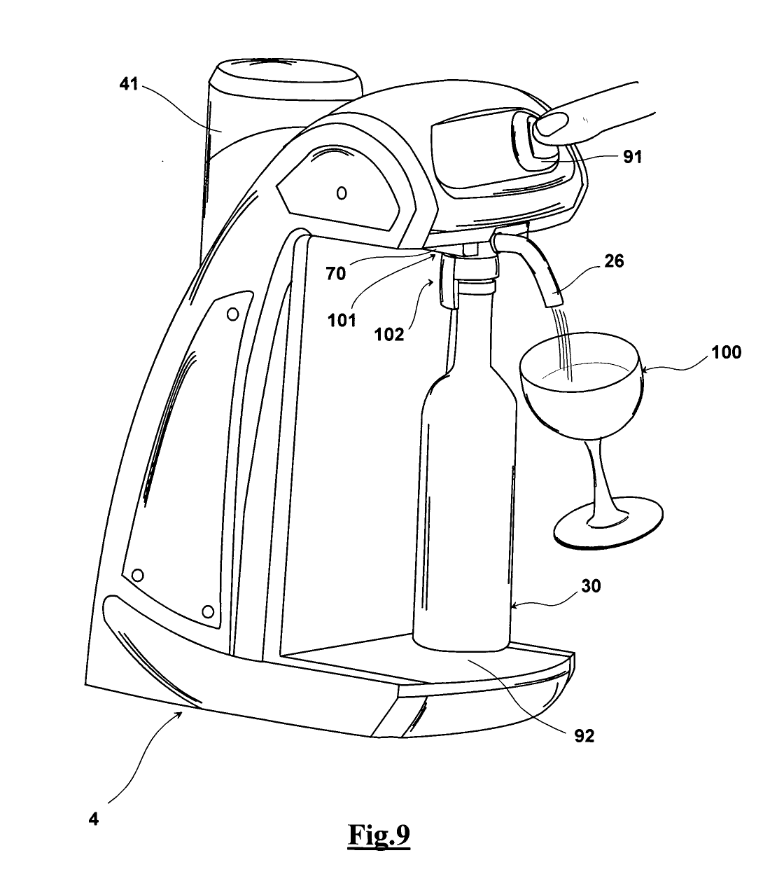

FIG. 9 shows the operation of the serving machine 4, once releasable fastening member 102 is put in guide 70 of fixed engagement member 101. By pressing push button 91 the wine exits through thin tube 26 and is poured into glass 100.

More precisely, the flow of gas supplied by pressing push button 91, with reference to FIG. 6, reaches duct 56 pushing movable element 53 towards below. Then, the gas reaches, through annular channel 81, the upper face of membrane 38, deforming it. This way, the membrane meets with a certain pressure the upper surface of flange 61 of joint member 60, ensuring a tight connection thereof. Stopper 39 is calibrated at a pressure suitable to ensure its opening with a certain delay of in order to allow the membrane 38 to deform. When stopper 39 open the gas enters the bottle, flowing through valve body 34 where holes 33 (FIG. 7) are made that check valve 32 to open. Once passed valve 32 the gas passes through chamber 83 and through inlet duct 24, entering the bottle.

Then, immediately, wine exits through thin tube 26 after having gone from the inner bottom region of the bottle up to neck end 25′ and then outlet duct 25 and eventually valve 27.

In an exemplary embodiment of the invention, shown in FIG. 11, instead of thin tube 26 a mixer 110 is provided, through which the wine passes and achieves the glass suitably oxygenated.

FIG. 10 shows a cross sectional view of the air/liquid mixer 110 consisting of a hollow body 113 that fits on a connection fitting 111 by means of threads 112.

In a preferred exemplary embodiment said threads 112 are selected from the group comprised of:
circular threads, for an forced coupling, or
screw threads helical, for an introduction screw.

In particular, connection 111 comprises a inlet zone 116 that fits valve 27. Furthermore, it has apertures 119 through which the environmental air, at atmospheric pressure, enters mixer 110. The tight connection between mixer 110 and valve 27 is ensured by the presence of o-rings 28.

In particular, body 113 houses a chamber 117 where the wine enters once passed valve 27, for then passing through a narrow cross section 115 and then flows towards a conical outlet duct 118. The narrow cross section 115 communicates with the outside through channels 114.

The oxygenation of wine is carried out owing to the attraction of air by Venturi effect. In fact, as well known, when passing through narrow cross section 115 the wine increases its own speed and generates a depression with consequent suction of air through channels 114, which mixes with the wine. Holes 119 in connection fitting 111 avoid a depression in chamber 117, maintaining it at atmospheric pressure.

Therefore, by arranging a mixer 110 as shown in FIG. 11, in glass 100 an already oxygenated wine is poured. This is particularly advantageous when wines that require oxygenation are tasted, like aged wines.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realize the different functions described herein could have a different nature without, for this reason, departing from the field of the invention. It is to be understood that the phraseology or terminology employed herein is for the purpose of description and not of limitation.

1. An apparatus for serving, without oxygen, from an already open bottle, a liquid that can be affected by oxygen, in particular wine, by insufflating inert pressurized gas in said bottle, said bottle having a bottleneck with a mouth, said apparatus comprising:
a normally closed releasable fastening member, which can be fixed at the mouth of said bottleneck, said releasable fastening member being equipped with:
means for a tight connection with a pressurized gas supply, adapted to receive said pressurized gas and to convey it in the bottle;
means for serving the liquid in occasion of the delivery of the gas, said means for serving being in hydraulic connection with an inner bottom region of the bottle;
means for keeping said bottle closed when it is withdrawn from said pressurized gas supply keeping the pressurized gas in the bottle.

2. Apparatus according to claim 1, wherein said means for keeping said bottle closed comprises:
a closure member that can be fixed at the mouth of said bottle by fastening means, said closure member having a pressurized gas inlet duct, passing through said closure member and leading into said bottle, and a liquid delivery duct, for leading out the liquid from an inner bottom region of the bottle and serving it outside;
a check valve on said inlet duct, adapted to be open when supplying the pressurized gas and to be closed in all the other situations;
a check valve on said liquid delivery duct.

3. Apparatus, according to claim 2, wherein said closure member comprises a cylindrical portion capable of tightly engaging in the bottleneck.

4. Apparatus, according to claim 1, wherein said means for a tight connection with a pressurized gas supply comprises a coupling surface engageable with a fixed engagement member belonging to said pressurized gas supply, wherein when said coupling surface engages with said fixed engagement member, said pressurized gas supply is in pneumatic tight connection with said inlet duct.

5. Apparatus, according to claim 4, wherein said coupling surface is engageable with said fixed engagement member by a coupling selected from the group comprised of:
bayonet coupling;
screw coupling;
snap coupling;
sliding coupling;
magnetic coupling.

6. Apparatus, according to claim 2, wherein said means for fixing said closure member at the mouth of said bottle comprises a bush in which said closure member is engageable, said bush having a hook portion that can be fixed to an edge protruding from said bottleneck.

7. Apparatus, according to claim 1, wherein said means for serving the liquid are in hydraulic connection with said liquid delivery duct and are selected from the group comprised of:
a thin liquid free outlet tube
a thin liquid outlet tube with a opening/closing valve;
an air/liquid mixer.

8. Apparatus, according to claim 7, wherein said opening/closing valve on said thin tube is selected from the group comprised of:
a push button tap;
a handle tap;
a check valve that opens for serving the wine and that prevents air back flow into the bottle;
a solenoid valve.

9. Apparatus, according to claim 1, wherein said serving apparatus comprises a safety valve adapted to avoid the pressure of the gas in the bottle exceeds a threshold value.

10. A machine for serving, without oxygen, from an already open bottle, a liquid that that can be affected by oxygen, in particular wine, by insufflating inert pressurized gas in said bottle, comprises:
a normally closed releasable fastening member, which can be fixed at the mouth of said bottleneck, said releasable fastening member being adapted to receive said pressurized gas leading it into the bottle and comprising means for serving the liquid in occasion of the delivery of the gas;
a fixed engagement member adapted to receive said releasable fastening member;
a gas delivery valve associated with said fixed engagement member;
a pressurized gas supplier in pneumatic connection with said gas delivery valve;
tight engagement means between said gas delivery valve and said releasable fastening member;
means for testing the presence of said releasable fastening member.

11. Machine, according to claim 10, wherein said gas delivery valve is operated by a push button or equivalent operating device.

12. Machine, according to claim 10, wherein said gas delivery valve is selected from the group comprised of: a mechanical valve operated by said push button; a solenoid valve operated by said push button.

13. Machine, according to claim 10, where the tight engagement means between said gas delivery valve and said releasable fastening member comprises a membrane adapted to mate tightly the surface of said means for a tight engagement of said releasable fastening member, said membrane changing its shape under the pressure of the delivered gas to ensure said tight connection, a calibrated stopper being provided to allow the deformation of said membrane before allowing the flow of the gas towards said releasable fastening member.

14. Machine, according to claim 10, wherein said fixed engagement member comprises a sensor of presence of said releasable fastening member, whereby in presence/absence of said releasable fastening member said sensor respectively allows/blocks, the operation of said delivery valve.

15. Machine, according to claim 10, wherein said fixed engagement member is a guide member, and said releasable fastening member has a flange that slidingly engages with said guide, up to substantially aligning said releasable fastening member with said delivery valve.

16. Machine, according to claim 10, wherein said pressurized gas supplier comprises a safety pressure switch adapted to limit the pressure of the gas in the bottle below a predetermined pressure value.

17. Machine, according to claim 10, wherein said pressurized gas supplier is selected from the group comprised of:
a gas cylinder;
a gas supply network.

18. Machine, according to claim 17, wherein said gas cylinder has volume less than 1.5 litres.

19. Machine, according to claim 18, wherein said gas cylinder comprises a pressure reducing valve.

20. Machine, according to claim 10, wherein said pressurized gas is a inert gas and/or a noble gas not containing oxygen, in order not to oxidize the wine, and, in particular, is selected from the group comprised of:
nitrogen;
argon.

21. Machine, according to claim 10, wherein said machine comprises a plurality of fixed engagement members for respective coupling surfaces and respective bottles of different wines.

22. Machine, according to claim 10, wherein said means for serving the liquid are in hydraulic connection with said liquid delivery duct and are selected from the group comprised of:
a thin liquid free outlet tube
a thin liquid outlet tube with a opening/closing valve;
an air/liquid mixer.

23. Machine, according to claim 10, wherein said air/liquid mixer comprises a hollow body with a narrow cross section where air is attracted by Venturi effect and that oxygenates the wine.
